(19) United States
(12) Patent Application Publication
(10) Pub. No.: US 2026/0134300 A1
(43) Pub. Date: May 14, 2026

(54) ESTIMATION SYSTEM, ESTIMATION METHOD, AND TRAINED MODEL

(71) Applicant: TOYOTA JIDOSHA KABUSHIKI KAISHA, Toyota-shi (JP)

(72) Inventor: Sei KATO, Kawasaki-shi (JP)

(73) Assignee: TOYOTA JIDOSHA KABUSHIKI KAISHA, Toyota-shi (JP)

(21) Appl. No.: 19/254,498

(22) Filed: Jun. 30, 2025

(30) Foreign Application Priority Data
Nov. 12, 2024 (JP) 2024-197602

(51) Int. Cl. G06N 5/022

(52) U.S. Cl. CPC G06N 5/022

(57) ABSTRACT

An estimation system according to the present disclosure inputs input data to a trained model. The trained model is a model that is trained by machine learning using a learning data set including first data including failure diagnosis data that is data for diagnosing a failure for each of a plurality of types of failures of the device, and second data including history data indicating a repair history for the failure in natural language. The input data is first data on a detection failure that is a failure detected by the device. The estimation system obtains data in which at least one of an occurrence factor and a repair method of the detection failure indicated by the input data is indicated in natural language as output data from the trained model.

### CROSS-REFERENCE TO RELATED APPLICATION

This application claims priority to Japanese Patent Application No. 2024-197602 filed on Nov. 12, 2024. The disclosure of the above-identified application, including the specification, drawings, and claims, is incorporated by reference herein in its entirety.

### BACKGROUND

### 1. Technical Field

The present disclosure relates to an estimation system, an estimation method, and a trained model.

### 2. Description of Related Art

Japanese Unexamined Patent Application Publication No. 2010-241263 (JP 2010-241263 A) describes a failure diagnosis device that supports reproducing a failure in response to a failure code in a vehicle failure diagnosis.

### SUMMARY

However, in the technique described in JP 2010-241263 A, it is possible to reproduce the failure in response to the failure code, but a factor of the failure or a repair method is not specified even though a situation is reproduced. Therefore, there is a demand for developing a technique for easily and quickly specifying a factor of a failure or a repair method from failure diagnosis data in which a failure is diagnosed.

An estimation system according to the present disclosure is configured to:
input, as input data, first data for a detection failure that is a failure detected in equipment to a trained model obtained by performing machine-learning on a learning data set including the first data including failure diagnosis data that is data obtained by diagnosing a failure for each of a plurality of kinds of failures in the equipment and second data including history data indicating a repair history for the failure in natural language; and
obtain, as output data from the trained model, data indicating at least one of an occurrence factor and a repair method for the detection failure indicated by the input data, in natural language.

An estimation method according to the present disclosure includes
inputting, by a computer, as input data, first data for a detection failure that is a failure detected in equipment to a trained model obtained by performing machine-learning on a learning data set including the first data including failure diagnosis data that is data obtained by diagnosing a failure for each of a plurality of kinds of failures in the equipment and second data including history data indicating a repair history for the failure in natural language, and obtaining, by the computer, as output data from the trained model, data indicating at least one of an occurrence factor and a repair method for the detection failure indicated by the input data, in natural language.

A trained model according to the present disclosure is
a trained model that causes a computer to function to input input data and output output data. The trained model is obtained by performing machine learning using a learning data set including first data including failure diagnosis data that is data obtained by diagnosing a failure for each of a plurality of kinds of failures in equipment and second data including history data indicating a repair history for the failure in natural language, such that the first data for a detection failure that is a failure detected in the equipment is input as the input data, and data indicating at least one of an occurrence factor and a repair method for the detection failure indicated by the input data, in natural language is obtained as the output data.

According to the present disclosure, it is possible to easily and quickly specify the factor of the failure or the repair method from the failure diagnosis data.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram showing a configuration example of a learning system that generates a trained model according to an embodiment;

FIG. 2 is a schematic diagram showing an example of an architecture of a learning system that generates a trained model according to the embodiment;

FIG. 3 is a flowchart for describing a processing example in a learning system that generates a trained model according to the embodiment;

FIG. 4 is a functional block diagram showing a configuration example of an estimation system according to the embodiment; and

FIG. 5 is a flowchart for describing a processing example in the estimation system according to the embodiment.

### DETAILED DESCRIPTION OF EMBODIMENTS

Hereinafter, the present disclosure will be described with an embodiment of the present disclosure, but the disclosure according to the claims is not limited to the following embodiment. In addition, all of the configurations described in the embodiment are not always needed as means for solving the problem.

### Embodiment

An estimation system according to the present embodiment is a system that estimates at least one of an occurrence factor and a repair method of a failure detected by a device using a trained model and outputs an estimation result as output data in a natural language. The failure may include a defect. The repair method may be referred to as a coping method or a repair procedure. The estimation system according to the present embodiment may be referred to as a failure factor estimation system or a generation factor estimation system in a case where data in which an occurrence factor is indicated in a natural language is obtained as output data. The estimation system according to the present embodiment may be referred to as a repair method estimation system in a case where data indicating a repair method in natural language is obtained as output data. In addition, the learning system according to the present embodiment generates the trained model. First, an example of a learning system will be described as an example of a learning stage, and then an example of an estimation system will be described as an example of an operation stage.

### Learning Stage

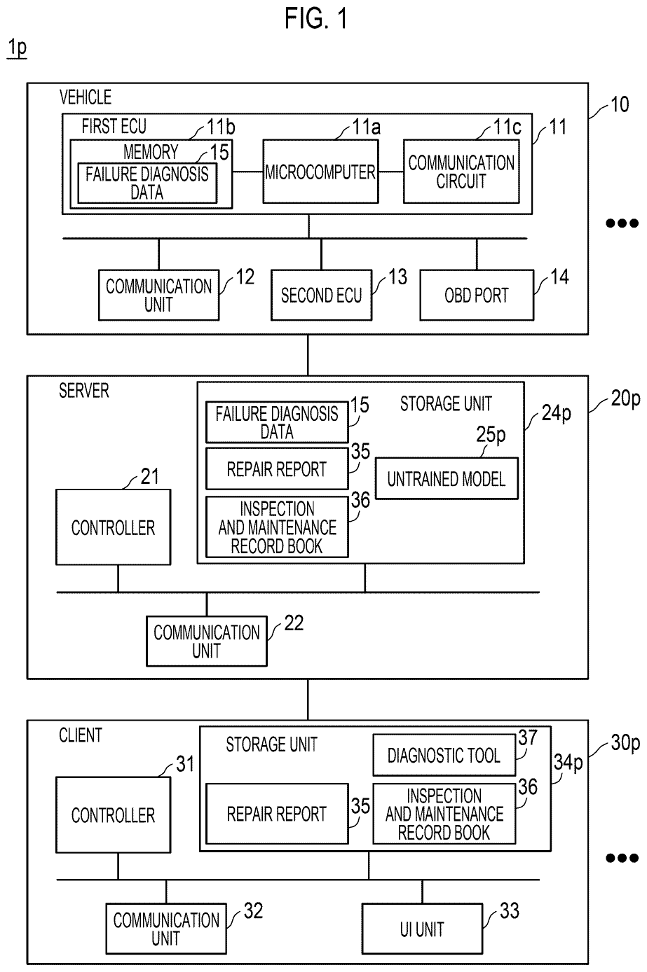

Next, a configuration example of a learning system that generates a trained model according to the present embodiment will be described with reference to FIG. 1. FIG. 1 is a functional block diagram showing a configuration example of the learning system.

A learning system 1p shown in FIG. 1 includes a vehicle 10, a server 20p, and a client 30p. Although FIG. 1 shows an example in which the learning system 1p includes a data acquisition system that acquires the learning data set, after the data is acquired, the learning can be performed solely by the server 20p.

The server 20p is, for example, a server computer used by a vehicle manufacturer. Although the server 20p is described as one device, the server 20p may be constructed as a distributed system in which functions are distributed to a plurality of devices. The server 20p may be a cloud server.

The client 30p is, for example, a client computer used by a vehicle dealer or a repairer, and is a general-purpose personal computer (PC) or the like. The client 30p may be a server that provides an application program that generates files such as the repair report 35 described later for a plurality of clients or manages the generated files. The client 30p can be connected to the server 20p via a network, such as a local area network (LAN) or a wide area network (WAN). The network may include a wireless communication network.

The vehicle 10 includes, for example, a first ECU 11, a communication unit 12, a second ECU 13, and an OBD port 14, and the first ECU 11, the communication unit 12, the second ECU 13, and the OBD port 14 can be connected by an in-vehicle network. ECU is an abbreviation for electronic control unit. OBD is an abbreviation of On-Board Diagnostics.

The first ECU 11 is an ECU that integrally controls the vehicle 10, and the control target thereof includes the second ECU 13. The first ECU 11 can include, for example, a microcomputer 11a, a memory 11b, and a communication circuit 11c. The communication circuit 11c is a circuit that communicates with other parts of the vehicle 10.

The memory 11b stores one or more types of data. The memory 11b can store the failure diagnosis data 15 as a result of performing the diagnostic of the failure including the determination of whether the failure is normal, as one kind of data. The failure diagnosis data 15 is data for diagnosing a failure of the vehicle 10. The failure diagnosis data 15 is, for example, the failure diagnosis data generated by executing the failure diagnosis on the second ECU 13 as a result of executing the self-diagnosis corresponding to the on-vehicle diagnosis in the vehicle 10 by the first ECU 11. Alternatively, the failure diagnosis data 15 is data acquired via the communication circuit 11c, the data being the failure diagnosis data generated by the second ECU 13 by performing a self-diagnosis.

The second ECU 13 is a unit that controls the engine. Although not shown, the second ECU 13 may also include a microcomputer, a memory, and a communication circuit in the same manner as the first ECU 11. The microcomputer built in the second ECU 13 performs control of the engine, performs a failure diagnosis including determination of whether the engine is normal, and generates failure diagnosis data as a diagnosis result. The control of the engine can include, for example, control of fuel injection, ignition timing, and idling speed. The second ECU 13 can execute a failure diagnosis of the second ECU 13 itself and can also execute a failure diagnosis of the sensor, the actuator, and the like connected to the second ECU 13. The generated failure diagnosis data is transmitted to the first ECU 11 by the built-in communication circuit and stored as the failure diagnosis data 15, but may be stored in the memory built in the second ECU 13 at least until the generated failure diagnosis data is transmitted. The second ECU 13 may be a unit that controls a part other than the engine, such as a unit that performs control of a lighting system.

The failure diagnosis data 15 may be, for example, a diagnostic trouble code (DTC). The DTC is a code for identifying a specific problem detected by the engine or another part. As illustrated in DTC, the failure diagnosis data 15 may include encoded data. The failure diagnosis data 15 may include, for example, freeze frame data (FFD). The FFD is related data that records a driving condition or state of the vehicle at the moment when the DTC is generated, and can be time-series data. The FFD can include, for example, an engine speed, a vehicle speed, and a temperature. The DTC and the FFD may be recorded when the abnormality is detected at the time of the regular inspection.

The communication unit 12 includes a communication interface for the vehicle 10 to perform wireless communication with the outside through the network. The OBD port 14 is a communication port connected to the terminal device to acquire the failure diagnosis data 15 from an external dedicated diagnostic tester or the like. Hereinafter, the terminal device is simply referred to as a tester. In a case where the failure diagnosis data 15 is acquired by using the tester, the failure diagnosis data 15 does not need to be stored in the memory 11b since the offboard diagnosis is performed instead of the onboard diagnosis. The first ECU 11 and the OBD port 14 can function as an in-vehicle failure diagnosis device.

The vehicle 10 may have a configuration without the first ECU 11. In this case, the second ECU 13 may be configured to transmit the failure diagnosis data 15 to the outside through the communication unit 12 or the OBD port 14. In addition, the vehicle 10 may include a plurality of second ECUs 13. Even when the vehicle 10 includes a plurality of second ECUs 13, the vehicle 10 may not include the ECU that performs the comprehensive control like the first ECU 11. Each of the second ECUs 13 may have a configuration in which the failure diagnosis function is provided and the failure diagnosis data 15 can be transmitted to the outside.

The client 30p is a device that generates the repair report 35 as a report of the result of repairing the vehicle 10. The client 30p is a device that provides the repair report 35 or the repair report 35 and the inspection and maintenance record book 36 to the server 20p in response to an instruction from the server 20p or voluntarily.

The client 30p includes, for example, a controller 31, a communication unit 32, a user interface (UI) unit 33, and a storage unit 34. The controller 31, for example, can be implemented by an integrated circuit and can be implemented by a processor, a working memory, a non-volatile storage device, or the like, for example. The processor is an MPU, a CPU, or the like. The client 30p stores a program for control executed by the processor in the storage device or the storage unit 34, and the processor reads the program into the work memory and executes the program. As a result, the client 30p can fulfill the function of the client 30p including the function of providing the data.

The communication unit 32 may include a communication interface that communicates with the server 20p via the network. The communication unit 32 may include a communication interface that communicates with the tester via a network or directly. Alternatively, the communication unit 32 may include a communication interface that is connected to the OBD port 14 to communicate with the vehicle 10 in order to function the client 30p as a tester.

The storage unit 34 stores various data, such as the repair report 35 or the repair report 35 and the inspection and maintenance record book 36, generated by a user of the client 30p. The storage unit 34 includes a diagnostic tool 37 as an application program executable by the controller 31.

The repair of the vehicle 10 can be performed by checking the failure diagnosis data 15 with a tester or the client 30p. The diagnostic tool 37 can be used as needed to confirm the failure diagnosis data 15. The client 30p can acquire the failure diagnosis data 15 from the vehicle 10 directly or via the tester, or can access the server 20p to acquire the failure diagnosis data 15. The confirmation of the failure diagnosis data 15 can be executed by the diagnostic tool 37, and the diagnostic tool 37 can present the diagnosis result to the user in the UI unit 33.

The repair report 35 is generated by a user of the client 30p or the like in a case where the failure is repaired. The repair report 35 is an example of history data indicating a repair history for the failure of the vehicle 10 in natural language. The repair report 35 is an electronic file of a report that shows a repair history for one or more types of failures that have occurred in the vehicle 10 in natural language. The repair report 35 may include a description of the content of the failure indicated by the failure diagnosis data 15 in natural language.

The inspection and maintenance record book 36 is generated by a user of the client 30p or the like when the inspection or the inspection and the maintenance are performed. The inspection and maintenance record book 36 is an electronic file of a record book in which inspection data indicating a result of inspecting the vehicle 10 or the inspection data and the content of the implemented maintenance are described in natural language. The inspection and maintenance record book 36 may include a description of the state of the vehicle 10 indicated by the failure diagnosis data 15 generated at the time of the inspection in natural language. Since a failure may be detected at the time of inspection that is not caused by a failure such as a regular inspection, the inspection and maintenance record book 36 may include the content of the repair report 35 or may include a link associated with the repair report 35. The state of the vehicle 10 may include a driving condition. The inspection data indicating the result of the inspection of the vehicle 10 may include the failure diagnosis data 15 in a case where the failure is not detected by the failure diagnosis, such as data indicating the fact that the failure diagnosis is performed.

The repair report 35 and the inspection and maintenance record book 36 may be both a document file including a text or a text and an image, or may be an image file obtained by scanning or imaging a paper document.

The server 20p is a device that functions as a data collection device and a learning device. The server 20p includes, for example, a controller 21, a communication unit 22, and a storage unit 24p. The controller 21, for example, can be implemented by an integrated circuit and can be implemented by a processor, a working memory, a non-volatile storage device, or the like, for example. The processor is a microprocessor unit (MPU), a central processing unit (CPU), or the like. The server 20p stores a program for control executed by the processor in the storage device or the storage unit 24p, and the processor reads the program into the work memory and executes the program. As a result, the server 20p can function as the server 20p including the data collection function of collecting the learning data set and the generation function of generating the trained model.

The communication unit 22 may include a communication interface that communicates with the vehicle 10 and the client 30p via the network. The storage unit 24p stores the failure diagnosis data 15 acquired from one or a plurality of vehicles 10 that are the targets of the learning process. The failure diagnosis data 15 can be acquired by the controller 21 from the communication unit 12 of the vehicle 10 or the communication unit 32 of the client 30p via the communication unit 22, for example. The failure diagnosis data 15 may include data read by a tester connected through the OBD port 14. The storage unit 24 also stores the repair report 35 or the repair report 35 and the inspection and maintenance record book 36 acquired by the controller 21 communicating with the communication unit 32 of the client 30p via the communication unit 22. The storage unit 24 also stores an untrained model 25p to be used for the learning process described later.

In the configuration as described above, the controller 21 collects the learning data set and stores the learning data set in the storage unit 24p, and executes the learning process of performing machine learning on the untrained model 25p. The learning data set may be added with appropriate information by the builder of the trained model. The learning data set is a data set including first data including a plurality of failure diagnosis data 15 and second data including history data for each failure or history data and inspection data.

Here, the above-described failure diagnosis data 15 included in the learning data set is data for diagnosing a failure for each of a plurality of types of failures in the vehicle 10. In any case, the learning data set includes the failure diagnosis data 15 for each kind of failure for the accurate estimation process. The failure diagnosis data 15 includes data indicating a failure obtained when the vehicle 10 is actually used before learning, but may also include data indicating a failure that is known in advance to occur in the vehicle 10. The failure diagnosis data 15 to be included in the learning data set may be the failure diagnosis data obtained when the failure is detected by the failure diagnosis. Note that, as described above, the failure may not be detected by the failure diagnosis for the inspection data. Therefore, the failure diagnosis data 15 to be included in the learning data set may include the failure diagnosis data in a case where the failure is not detected.

As described above, the example of the history data included in the second data is the repair report 35, and the example of the inspection data that can be included in the second data is the inspection and maintenance record book 36. By including the inspection data in the learning data set as described above, it is possible to grasp the occurrence or absence of a sign of the failure of the inspection place at the inspection point in time, the presence or absence of the replacement history of the component of the inspection place, and the like.

In the learning process, the controller 21 trains the untrained model 25p by using the learning data set to generate the trained model. Hereinafter, the trained model will be described as a trained model 25. The untrained model 25p can use a model, such as deep learning, but is not limited to an algorithm or the like. The untrained model 25p may be a model that can output output data with respect to input data in the estimation process described below, in the generated trained model 25. In a case where the time-series data is used as the first data, the untrained model 25p may use an algorithm corresponding to the time-series data. In addition, in a case where the data including the image is used as the second data, the untrained model 25p may use an algorithm corresponding to the image. In addition, the untrained model 25p is equipped with a language model, such as a large-scale language model, in order to include the second data in the learning data set.

The input data in the estimation process is first data including the failure diagnosis data 15 on the detection failure that is the failure detected by the vehicle 10, that is, the failure to be estimated. In the estimation process, the output data for the input data is data in which the occurrence factor and the repair method of the detection failure are described in natural language. The occurrence factor and the repair method are learned by machine learning from the repair report 35 or the repair report 35 and the inspection and maintenance record book 36 for the failure diagnosis data 15 in the learning data set. The occurrence factor to be included in the output data may be solely one or more main factors among the occurrence factors, that is, one or more main factors.

The first data included in the learning data set and the first data input in the estimation process may include data indicating a state of the vehicle 10 for a period before the occurrence of the failure indicated by the failure diagnosis data 15. For example, the first data may be time-series data including data indicating the result of the failure diagnosis before the failure occurrence, in addition to the failure diagnosis data 15 at the time of the failure occurrence. That is, the first data may include the failure diagnosis data 15 including at least the time of occurrence of the failure. As described in the FFD, the state of the vehicle 10 may include a driving condition.

In this example, in the estimation process during operation, the data indicating the state of the vehicle 10 for the period before the occurrence is included in the failure diagnosis data 15 at the time of occurrence, and the trained model 25 is input, so that the output in which the information before the occurrence of the failure is also taken into account can be performed.

In addition, the data to be included in the learning data set may be the data on the vehicle 10 of the same vehicle model. Note that vehicles that are different from each other merely in the shape of the vehicle may be regarded as the same vehicle model. For different types of vehicles that share a certain part, data on the common part may be included in the learning data set. Alternatively, in a case where the trained model 25 is not generated to be specialized for one specific vehicle model, the first data may include data indicating the vehicle model or type, or data indicating the vehicle model or type and the year of the vehicle, in addition to the failure diagnosis data 15. The year in this case is a year, or a year and month, or a year, month, and day when the vehicle 10 is manufactured.

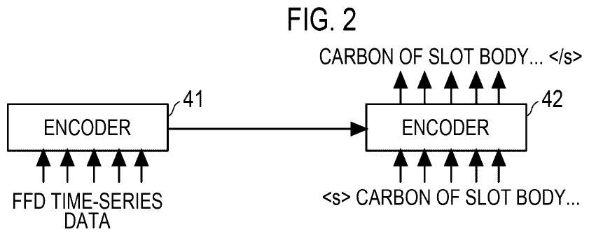

Next, an example of an architecture of a learning system that generates the trained model 25 will be described with reference to FIG. 2. FIG. 2 is a schematic diagram showing an example of the architecture.

In the learning system 1p, the controller 21 and the storage unit 24p function as a generator that generates the trained model 25 from the untrained model 25p by using the learning data set. As illustrated in FIG. 2, the generator may include an encoder 41 and a decoder 42 as an untrained model 25p.

As an example of the end-to-end architecture, the combination of the encoder 41 and the decoder 42 may be the encoder 41 as a Transformer and the decoder 42 as a Transformer. Alternatively, as an example of the lightweight architecture, the combination of the encoder 41 and the decoder 42 may be the encoder 41 as a GRU or an LSTM, and the decoder 42 as a GPT. Both the GRU and the LSTM are kinds of a recurrent neural network (RNN), and are models for learning a long-term dependency. The GRU is an abbreviation of a gated recurrent unit. LSTM is an abbreviation of Long Short-Term Memory. The combination of the encoder 41 and the decoder 42 is not limited to these examples.

The encoder 41 inputs the time-series data of the FFD as an example of the failure diagnosis data 15, encodes the time-series data into a code processable by the decoder 42, and outputs the code to the decoder 42. The decoder 42 inputs the code and the text data of the natural language included in the repair report 35 or the repair report 35 and the inspection and maintenance record book 36. For the inputs, the decoder 42 generates the data in which the occurrence factor and the repair method of the failure included in the time-series data of the FFD are described in natural language by the autoregressive generation and outputs the data. In FIG. 2, the decoder 42 is shown to input “<s> carbon of slot body . . . ” together with the output code from the encoder 41 and output data such as “carbon of the slot body . . . </s>”. The <s> tag and the </s> tag respectively represent a start tag and an end tag.

The controller 21 performs machine learning on the relationship between the input data and the output data for all the learning data sets for the encoder 41 and the decoder 42. Thereafter, the controller 21 evaluates the performance of the machine-learned model using another verification data set, and completes the generation of the trained model 25 when the performance evaluation that can be used for operation is obtained.

As described above, the server 20p executes machine learning that associates the failure diagnosis data 15 with the natural language as the repair history based on the failure diagnosis data 15 as the learning device. As a result, the server 20p obtains the trained model 25 as an estimator that outputs the occurrence factor and the repair method in natural language when the failure diagnosis data 15 is input during operation. The estimator may be referred to as a predictor. Since the trained model 25 is a model that estimates the factor of the occurrence factor and the repair method, the trained model 25 may be referred to as a factor estimation model and a repair method estimation model.

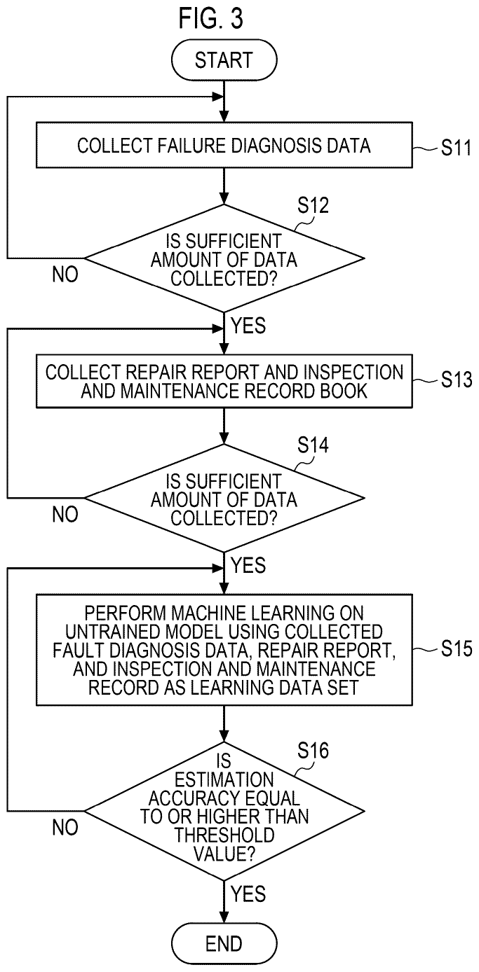

A processing example in the learning system 1p that generates the trained model 25 according to the present embodiment will be described with reference to FIG. 3. FIG. 3 is a flowchart for describing the processing example.

First, the controller 21 collects the failure diagnosis data 15 for the vehicles 10 from the vehicle 10 or the client 30p and stores the failure diagnosis data 15 in the storage unit 24p (S11). The failure diagnosis data 15 may include, for example, a DTC and an FFD. In addition, in a case where the failure occurrence position and the failure occurrence date and time are not included in the FFD, the failure diagnosis data 15 may be included separately at the time of collection.

Next, the controller 21 determines whether the collected failure diagnosis data 15 is sufficient (S12). When a sufficient amount of the failure diagnosis data 15 is not collected, that is, when NO in S12, the controller 21 returns to S11 and continues the collection. In a case where the determination in S12 is YES, the controller 21 collects the repair report 35 and the inspection and maintenance record book 36 generated by the clients 30p from each client 30p and stores the repair report 35 and the inspection and maintenance record book 36 in the storage unit 24p (S13).

The controller 21 determines whether the collected repair report 35 and the inspection and maintenance record book 36 are sufficient (S14). When a sufficient amount of the repair report 35 and the inspection and maintenance record book 36 is not collected, that is, when NO in S14, the controller 21 returns to S13 and continues the collection. In a case where the determination in S14 is YES, the controller 21 collects the failure diagnosis data 15, the repair report 35, and the inspection and maintenance record book 36 as the learning data set.

Examples of the failure diagnosis data 15 include a P0300 code indicating a misfire problem in a cylinder in an engine. For example, in the case of the first cylinder, the code is obtained as “P0301”. Misfire occurs when the combustion of fuel is insufficient or when the ignition plug is damaged, and is a failure in which there is a possibility that the catalytic converter of the vehicle 10 is damaged in an extreme situation.

The repair report 35 generated in response to the failure indicated by P0300 and collected includes, for example, a result of confirming wear as a result of confirming the ignition plug with respect to P0300, and a result of replacing the ignition plug to eliminate the error. In addition, the repair report 35 in this case includes, for example, the confirmation of the wear described above, the fact that the spark plug was replaced but the error was not resolved, and the fact that the carbon finally adhered to the throttle body was cleaned to resolve the error. For example, when the failure diagnosis data 15 indicates a misfire of the engine, not only the ignition failure but also a fuel failure or a failure in the engine may be the occurrence factor. Therefore, by collecting more data as the learning data set, the occurrence factor and the repair method can be learned. When the repair method is also learned, for example, when the detection of the misfire of the cylinder of the engine is exemplified, the repair report 35 may include an actual repair place including, for example, an item to be checked in response to the detection, a method of checking each item, and an actual check result.

In addition, the repair report 35 may include the date and time of occurrence of the failure in addition to the position of occurrence of the failure that is exemplified by the number of the cylinder. As a result, it is possible to associate the repair report 35 with the failure diagnosis data 15 during machine learning. The inspection and maintenance record book 36 generated and collected in association with the misfire may include, for example, information on which spark plug is replaced at what time or when the carbon is cleaned.

Although an example of the misfire of the cylinder has been described for the learning data set, data on each type of failure that has occurred in each vehicle 10, and data of the repair report 35 and the inspection and maintenance record book 36 generated for the vehicle 10 are collected.

When the collection of the learning data set is completed, the controller 21 performs machine learning of the untrained model 25p using the learning data set (S15).

In the trained model 25 generated by the machine learning, for example, the failure diagnosis data 15 shown in P0301 is input as input data. As a result of the above, the following output data can be estimated and output as a result of the machine learning from the repair report 35 for the P0300. For example, the output data is data in which the occurrence factor is described as a misfire of the first cylinder in a natural language, and a need to replace the spark plug of the first cylinder and clean the throttle body is described as a repair method.

After the machine learning, the controller 21 determines whether the estimation accuracy of the occurrence factor and the repair method in the generated trained model 25 is equal to or higher than a threshold value by using the verification data set (S16). When NO in S16, the controller 21 returns to S15, and the controller 21 changes the hyperparameter or the like or increases or decreases the number of learning data sets as needed, and performs machine learning again. When the determination in S16 is YES, the trained model 25 obtained there is used as the trained model to be used during operation.

### Operation Stage

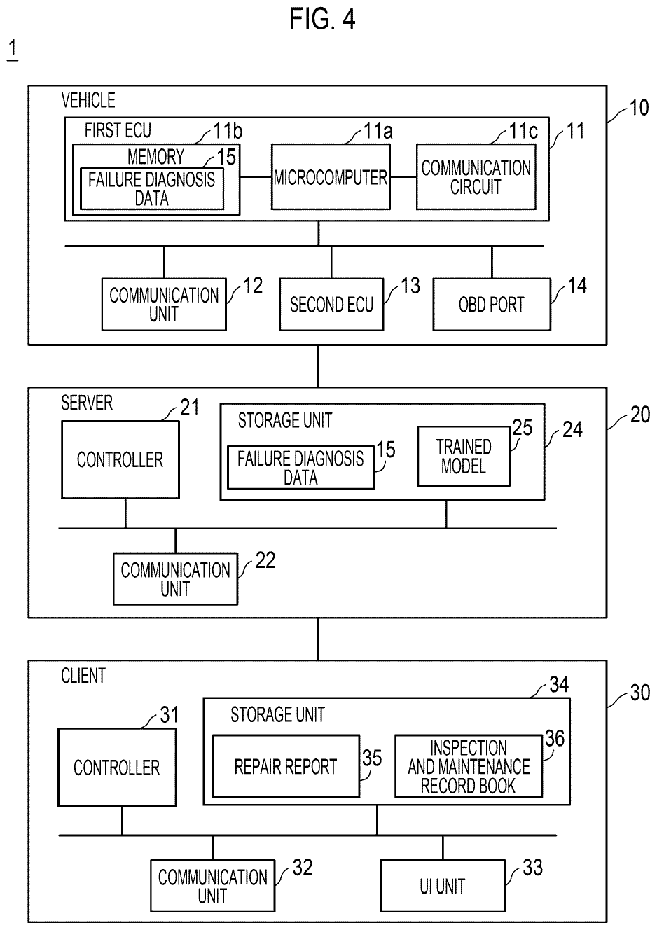

Hereinafter, a configuration example of the estimation system according to the present embodiment will be described with reference to FIG. 4. FIG. 4 is a functional block diagram showing a configuration example of the estimation system. The equipment to be estimated for the failure as described above can be a vehicle or a part of the vehicle, and an example of the vehicle will be described below. Note that the target device is not limited to a vehicle or a part of the vehicle.

An estimation system 1 shown in FIG. 4 includes a vehicle 10, a server 20, and a client 30. The server 20 and the client 30 are computers that execute estimation processing instead of learning processing in the configuration example of the server 20p and the client 30p, and a description of the basic configuration example will be omitted. The server 20 and the client 30 may have functions of a server 20p and a client 30p, respectively. That is, the estimation system 1 may be constructed as a system incorporating the learning system 1p.

The server 20 stores the trained model 25 in the storage unit 24 such that the trained model 25 is executable by the controller 21. The trained model 25 is a trained model that causes the server 20 to function as a computer to input the input data and output the output data.

The controller 21 is configured to execute the following estimation process. The estimation process inputs the input data to the trained model 25 and outputs the output data as the estimation result. As described in the learning stage, the input data in the estimation process is first data including the failure diagnosis data 15 on the detection failure that is the failure detected by the vehicle 10, that is, the failure to be estimated. In the estimation process, the output data for the input data is data in which at least one of an occurrence factor and a repair method of the detection failure is described in natural language. Even in a case where the occurrence factor is not included in the output data and solely the repair method is included in the output data, the sales store or the repairer of the vehicle 10 can perform the repair by referring to the output data. The estimation process may be executed by storing the trained model 25 in the storage unit 34 on the client 30 side and executing the estimation process by the controller 31 of the client 30.

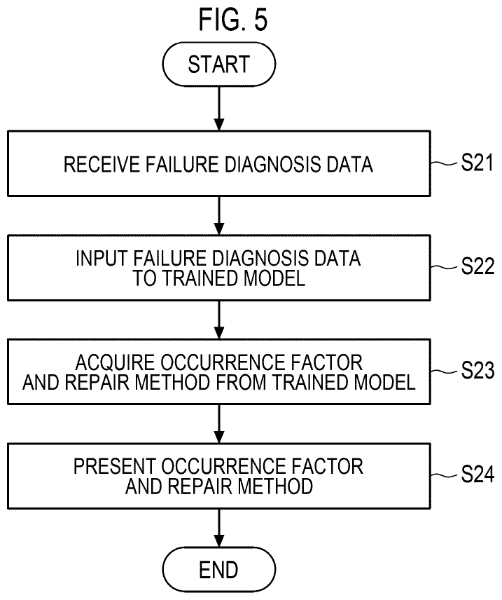

Next, an example of the estimation process in the estimation system 1 according to the present embodiment will be described with reference to FIG. 5. FIG. 5 is a flowchart for describing the estimation processing example.

When the operation of the estimation process is started, first, the controller 21 receives the failure diagnosis data 15 from the vehicle 10 or the client 30 via the communication unit 22 and stores the failure diagnosis data 15 in the storage unit 24 (S21). In S21, the failure diagnosis data 15 is stored for managing the failure diagnosis data 15 or for relearning the trained model 25 later, but the failure diagnosis data 15 is temporarily stored in a case where the failure diagnosis data 15 is used solely for the estimation process.

Next, the controller 21 inputs the received failure diagnosis data 15 to the trained model 25 (S22). The controller 21 acquires the data in which the occurrence factor and the repair method are described in natural language from the trained model 25 in response to S22 (S23). The result is displayed on the UI unit 33 or output as a voice (S24), and the operation is ended. With such a presentation, the sales store or the repairer of the vehicle 10 can confirm the result of estimation of the factor of the occurrence factor and the repair method. In S24, when the generated and stored trained model 25 is a model that outputs solely one of the occurrence factor or the repair method, the failure cause or the repair method is output. The processing illustrated in FIG. 5 can be executed, for example, each time the failure diagnosis is executed or each time a certain number of times of the failure diagnosis is executed.

In addition, after S24, the sales store or the repairer of the vehicle 10 can generate the repair report 35 or the inspection and maintenance record book 36 by using the client 30 and can store the generated repair report 35 or the inspection and maintenance record book 36 in the storage unit 34. The repair report 35 or the inspection and maintenance record book 36 may be transmitted to the server 20 and managed. The server 20 may use the failure diagnosis data 15 stored in the storage unit 24 and the repair report 35 or the inspection and maintenance record book 36 for relearning the trained model 25.

Before describing the effects of the present embodiment, a comparative example will be described. In this comparative example, the DTC and the FFD are analyzed in the offboard diagnosis using the tester or in the onboard diagnosis, and the inspection is performed in accordance with the maintenance manual. Since there are a wide variety of occurrence factors that cause a problem corresponding to the DTC, it takes time to specify the factor in this comparative example. For example, in a case where a failure code P0300 corresponding to the engine misfire is observed, as a factor thereof, for example, a plurality of various factors such as wear of an ignition plug, a failure of a fuel injector, a leak of a head gasket, and a failure of a camshaft sensor is considered. In this case, the sales store or the repairer inspects the vehicle in accordance with the maintenance manual, but in order to specify the occurrence factor of the failure, the problem needs to be discriminated while eliminating each factor, which takes time.

On the other hand, in the estimation system 1 according to the present embodiment, the occurrence factor is estimated by using the trained model 25 generated as described above, so that the time needed for the discrimination of the occurrence factor can be shortened. That is, according to the present embodiment, the occurrence factor of the failure, the repair method, or both the occurrence factor of the failure and the repair method can be easily and quickly specified from the failure diagnosis data.

In the present embodiment, the repair report 35 described in a natural language that is a DTC and a repair history associated with the DTC, as a repair record at a store or a repairer is not merely accumulated, but a trained model 25 capable of estimating an occurrence factor of a failure or a repair method can be generated by using the repair report 35. In the present embodiment, the DTC and the FFD associated with the DTC can be generated by using the vehicle manufacturer, and the trained model 25 that can estimate the DTC and the FFD can be generated. As described above, in the present embodiment, the failure diagnosis data 15 exemplified by the DTC or the FFD as the time-series data and the repair history of the corresponding failure as the natural language that is different from the failure diagnosis data 15 can be utilized by including the failure diagnosis data 15 and the repair history in the learning data set. The trained model 25 is generated as a trained model including a language model, as a model obtained by machine learning the learning data set. Note that the part to be trained may be a part other than the language model. That is, the input of the second data to the untrained model and the output of the output data may be performed using the existing language model, and solely the part of the untrained model may be subjected to machine learning.

Further, the present disclosure includes a mode as an estimation method in which the computer performs the above-described estimation and a mode as a learning method in which the computer performs the above-described learning, as illustrated in FIG. 3 or 5. The present disclosure also includes a mode of the trained model, a mode of the program that causes the computer to execute the estimation method, and a mode of the program that causes the computer to execute the training method as described above. For example, a part or all of the processing in the vehicle 10, the server 20, 20p, the client 30, 30p, and the like can be realized as a computer program. The program includes an instruction set (or a software code) that causes the computer to perform one or a plurality of the functions described in the embodiments when the computer reads the program. The program may be stored on a non-transitory computer-readable medium or a tangible storage medium. The program may be transmitted on a temporary computer-readable medium or a communication medium, such as an electrical, optical, acoustic, or other form of propagated signal.

The present disclosure is not limited to the embodiment, and can be appropriately modified without departing from the spirit. For example, in the above embodiment, the example in which the device is the vehicle has been described, but the device may be another type of device that is not the other type of moving body or the moving body.

What is claimed is:

1. An estimation system configured to:
input, as input data, first data for a detection failure that is a failure detected in equipment to a trained model obtained by performing machine-learning on a learning data set including the first data including failure diagnosis data that is data obtained by diagnosing a failure for each of a plurality of kinds of failures in the equipment and second data including history data indicating a repair history for the failure in natural language; and
obtain, as output data from the trained model, data indicating at least one of an occurrence factor and a repair method for the detection failure indicated by the input data, in natural language.

2. The estimation system according to claim 1, wherein the first data includes data indicating a state of the equipment for a period prior to occurrence of the failure indicated by the failure diagnosis data.

3. The estimation system according to claim 1, wherein the second data includes inspection data describing a result of inspecting the equipment in natural language.

4. An estimation method comprising:
inputting, by a computer, as input data, first data for a detection failure that is a failure detected in equipment to a trained model obtained by performing machine-learning on a learning data set including the first data including failure diagnosis data that is data obtained by diagnosing a failure for each of a plurality of kinds of failures in the equipment and second data including history data indicating a repair history for the failure in natural language; and
obtaining, by the computer, as output data from the trained model, data indicating at least one of an occurrence factor and a repair method for the detection failure indicated by the input data, in natural language.

5. A trained model that causes a computer to function to input input data and output output data,
wherein the trained model is obtained by performing machine learning using a learning data set including first data including failure diagnosis data that is data obtained by diagnosing a failure for each of a plurality of kinds of failures in equipment and second data including history data indicating a repair history for the failure in natural language, such that the first data for a detection failure that is a failure detected in the equipment is input as the input data, and data indicating at least one of an occurrence factor and a repair method for the detection failure indicated by the input data, in natural language is obtained as the output data.
